(19) United States
(12) Patent Application Publication
(10) Pub. No.: US 2022/0406182 A1
(43) Pub. Date: Dec. 22, 2022

(54) METHOD FOR ASSIGNING THE LANE IN WHICH A VEHICLE IS CURRENTLY DRIVEN

(71) Applicant: Volkswagen Aktiengesellschaft, Wolfsburg (DE)

(72) Inventors: Stefan Gläser, Braunschweig (DE); Daniel Reimann, Braunschweig (DE); Andreas Pfadler, Berlin (DE); Julia Kwasny, Wolfsburg (DE); Sven Klomp, Uetze / Dollbergen (DE); Sandra Kleinau, Rötgesbüttel (DE)

(21) Appl. No.: 17/844,475

(22) Filed: Jun. 20, 2022

(30) Foreign Application Priority Data
Jun. 21, 2021 (EP) 102021206355.1

(51) Int. Cl. G08G 1/0967; G08G 1/01

(52) U.S. Cl. CPC G08G 1/096741; G08G 1/0112; G08G 1/0141

(57) ABSTRACT

Technologies and techniques for assigning the lane in which a vehicle is currently driven, wherein input variables of at least one data source are detected to determine the lane currently being driven in, and wherein at least one data source includes signals from an environmental sensor system of the vehicle. In cases in which the possibility of unequivocal assignment of the lane in which a vehicle is currently driven is improved, it is provided that at least one data source includes a C2X communication.

### RELATED APPLICATIONS

The present application claims priority to German Patent App. No. 10 2021 206 355.1, filed Jun. 21, 2021 to Daniel, et al., the contents of which is incorporated by reference in its entirety herein.

### TECHNICAL FIELD

The present disclosure relates to a process for assigning the lane in which a vehicle is currently driven, whereby input variables of at least one data source are detected to determine the lane currently being driven in, and wherein at least one data source comprises signals from an environmental sensor system of the vehicle.

### BACKGROUND

For driver information systems, and driver assistance systems, particularly in motor vehicles, the correct assignment of one's own vehicle as well as the surrounding vehicles to the lane in which they are currently driven is becoming increasingly important. To this end it is necessary that the navigation system have information as to which lane the vehicle is currently located in. Particularly at complex highway interchanges it is important that the driver be given precise and reliable driving directions.

Assistance functions, such as maintaining distances or following at a particular distance, can also benefit significantly from a precise assignment of lanes for one's own vehicle as well as the assignment of other road users. Since the angular resolution of, for example, radar, is limited, it cannot always be reliably recognized whether the vehicle ahead is driving in one's own lane or the adjacent lane. This leads, for example, to the fact that due to the activated assistance system one's own vehicle brakes since another vehicle on a highway brakes on a highway exit, even though one's own lane is free. Not least, safety functions such as “blind spot detection” also need precise lane information in order to decide whether a warning is needed.

Various approaches to a solution for precise lane recognition are known in the prior art. Among them is, for example, the use of a high resolution map in connection with highly precise camera localization. In addition, different sensors, such as gyroscopes and wheel sensors, are used for “map matching”. Furthermore, the “optical lane matcher” is also known.

DE 10 2015 209 467 A1, for example, shows a method for estimating lanes, which is used in a driver assistance system. The lanes are estimated through the evaluation of input data from different sensors.

Map matching is mostly based on GNSS, maps, wheel sensors, gyroscopes and dead reckoning algorithms Typically the assignment here does take place precisely in accordance with the driving direction, but not always in accordance with the lane. The positioning of one's own vehicle in accordance with the lane is realizable with highly precise maps and highly precise localization. But both are not always present. The aforementioned solutions are suited to current customer functions, but with respect to lane precision, due to availability and/or precision, are prone to errors particularly for new customer functions. Aside from that, the additional costs in the vehicle are significant for some methods.

### SUMMARY

The present disclosure is directed to solving problems relating to specifying a method in which the opportunity of unequivocal assignment of the lane driven in by the vehicle is improved and whereby at the same time cost efficiency is taken into account.

In some examples, this problem is initially solved through the use of at least one data source comprising a car-to-everything (C2X) (or vehicle-to-everything “V2X”) communication.

The basic idea of this approach includes the fact that, based on C2X communication as well as already built-in environmental sensor systems, such as a radar, Lidar and/or one or multiple cameras, additional information concerning the reliable assignment of one's own vehicle to the lane in which it is currently driving may be provided.

Modern vehicles are frequently equipped with C2X radio modules in order to exchange standardized messages with one another and with the infrastructure. Examples of this are the CAM (Cooperative Awareness Message), or DENM (Decentralized Environmental Notification Message) of the ETSI Standard for C2X communication. The first message includes the position and speed of the sending vehicle.

In some examples, the vehicle may communicate with at least one other vehicle using C2X communication, that information concerning the position of the vehicle is transmitted to the other vehicle and that information concerning the position of the other vehicle is transmitted to the vehicle. Through the vehicles' communication with one another, the vehicles can share their positions. Through linking with the environmental sensor system, the position of the vehicle can be determined more precisely.

Additionally or alternatively, the vehicle may communicate through C2X communication with infrastructure. In some examples, the vehicle may communicate with a camera and a corresponding evaluation device that is positioned in the area of the road. A camera arranged at a predetermined height offers additional angles of view to identify additional vehicles that might possibly be concealed by vehicles behind. It may be assumed that a vehicle driving ahead is completely concealed by the vehicle behind. The vehicle behind may send a C2X message to the infrastructure. If the infrastructure is for example, a camera, then by means of the angle of inclination and the resolution of the camera as well as through the determination of the height of the vehicle behind, the spaces ahead of the vehicle behind are calculated. In this manner the position of the vehicle ahead can be localized in both a lateral and a longitudinal position to a certain area, for example a lane, and thus more precisely determined.

In some examples, environmental sensor systems may be utilized using radar and/or ultrasound. Radar is a radio-supported detect measurement of distance, whereby the corresponding radar sensor is a beam-based sensor and is used to detect objects, for example other vehicles and pedestrians, and to measure their distance from the vehicle as well as their relative speed. To this end, electromagnetic waves are emitted. The electromagnetic wages reflected by the objects are received and evaluated. The values measured are converted into electrical signals that are evaluated in special control devices (cf. http://www.mein autolexikon.de/fahrerassistenzsysteme/radarsensor.html).

Ultrasound sensors are likewise beam-based sensors. They send and receive sounds waves the frequencies of which lie above the range that can be perceived by human hearing, over 16 kHz. These sound waves are mostly sent by so-called piezo actuators over a membrane. The sound waves disperse in the surrounding air and are reflected by obstacles. The reflected echo signals are registered by the sensors and evaluated by a central control device. From the run time, i.e. the time that the echo signal needs to arrive at the sender, the distance to the corresponding object is calculated (cf. https://www.mein-autolexikon.de/fahrerassistenzsysteme/ultraschallsensor.pdf).

In some examples, the environmental sensor system may include a side area sensor and that by means of side area sensor system information concerning the lateral position of the vehicle on the road is determined, whereby from the lateral position, conclusions as to the lane currently being driven in are made possible. Thus, for example, it is conceivable that using other vehicles detected that are next to the vehicle, the vehicle can draw conclusions as to its own lateral position, particularly the lane driven in. If, for example, other vehicles are driving to the left and right of the vehicle and the vehicles communicate with one another, they can reciprocally identify one another and thus confirm that another vehicle is driving to the right of the vehicle. With this information the vehicles can determine their position. If, for example, another vehicle is detected to the left of the vehicle, it is concluded that the vehicle cannot be in the left lane. Correspondingly, it can also be concluded that the vehicle is not in the right lane if another vehicle is detected to the right of the vehicle.

In order to further improve the precision of the determination of the lane being driven in, in a further configuration, it is provided that at least one data source comprises information concerning the road topology and that by means of the information on the road topology the number of lanes of at least the road segment currently being driven in can be determined.

In addition, in a further configuration of the present disclosure, it is provided that signals to indicate the driving direction of other vehicles in the vehicle's environment be detected and that through knowledge of the road topology in conjunction with the signals detected to indicate the driving direction, conclusions as to the position of the vehicle are made possible. The knowledge of the road topology, specifically the knowledge concerning the number of turning lanes, also helps in assigning the lane. A vehicle that is signaling left and that is located shortly before the intersection is most probably in a left turning lane. If its lateral position is so unequivocally identifiable, then by means of relative positioning of the surrounding vehicles their lanes, too, can be absolutely assigned.

In a further configuration, it is provided that the environmental sensor system comprises a front sensor system and that by means of the front sensor system the position of vehicles ahead is determined. With the aid of the front sensor system a lane assignment can be implemented. If other vehicles are driving ahead of the vehicle then, particularly with knowledge of the road topology, using the vehicles ahead that are detected, the lateral position of the vehicle itself on the road can be determined. In the event that the vehicles communicate with one another via C2X, the vehicle can also share the positions of the vehicles ahead with them. Likewise, the vehicles ahead, with knowledge of their own lateral position on the road, can determine the lateral position of the car behind and share this position with the vehicle behind or the vehicle via C2X.

Additionally or alternatively, in a further configuration, it is provided that the environmental sensor system comprises a rear sensor system and that by means of the rear sensor system the position of vehicles behind is determined. Analogously to the front sensor system, with the aid of the rear sensor system a lane assignment can be implemented. If other vehicles are driving behind the vehicle, then particularly with knowledge of the road topology, using the vehicles behind that are detected, the lateral position of the vehicle on the road can be determined. In the event that the vehicles communicate with one another via C2X, the vehicle can also share their positions with the vehicles behind. Likewise the vehicles behind, with knowledge of their own lateral position on the road, can determine the lateral position of the vehicle ahead and share this position with the vehicle ahead or the vehicle via C2X.

In some examples, the position of a guardrail may be determined by means of detecting the reflective characteristics of objects and that depending on the position of the guardrail, the lateral position of the vehicle on the road is determined. If the guardrail can be classified as an object, then based on the lateral offset of the vehicle's position to the guardrail, the lane currently driven in can be determined. The classification as “guardrail” is determined through the reflective characteristics, for example “radar cross section”.

Unless otherwise stated in an individual case, the various configurations of the present disclosure cited in this application may be advantageously combined with one another.

### BRIEF DESCRIPTION OF THE DRAWINGS

The present disclosure shall be explained below in exemplary embodiments using the associated drawings. These show:

FIG. 1 illustrates a schematic representation of the execution of an exemplary embodiment of a method on a four-lane highway, according to some aspects of the present disclosure;

FIG. 2 illustrates a schematic representation of a further exemplary embodiment according to some aspects of the present disclosure; and

FIG. 3 illustrates a schematic representation of communication between the infrastructure and at least one vehicle, according to some aspects of the present disclosure.

### DETAILED DESCRIPTION

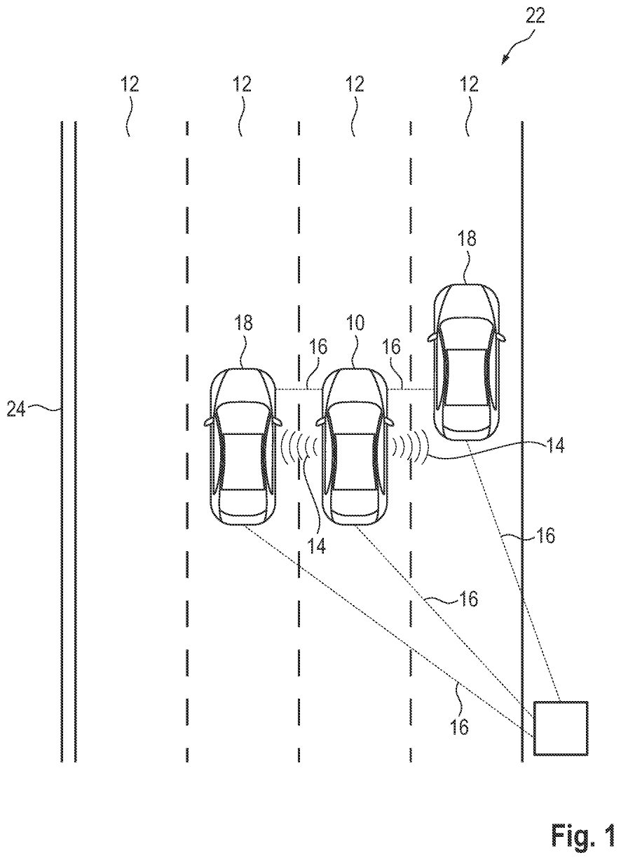

FIG. 1 shows a vehicle 10, that is driving on a lane 12 of a highway. By means of an environmental sensor system 14 and a C2X communication 16 the vehicle 10 is able to detect other vehicles 18 and to communicate with them. In addition, elements of the infrastructure 20, for example a camera that is arranged on the edge of the highway 22, can communicate with the vehicle via the C2X communication 16. In this exemplary embodiment the environmental sensor system 14 a side areas sensor system. Based on the signals detected by the environmental sensor system 14 and the C2X communication 16 conclusions may be drawn as to the lane 12 currently being driven in by the vehicle 10.

With the aid of the side area sensor system 14 information concerning the lateral position of the vehicle 10 on the road 22 can be determined, whereby from the lateral position, conclusions as to the lane 12currently driven in are made possible. In FIG. 1 it may be seen that next to the vehicle 10 other vehicles 18 are driving on the lane 12 next to the lane 12 in which the vehicle 10 is driving 12. Through the C2X communication 16 of the vehicle 10 and the other vehicles 18 with one another, they can reciprocally identify one another and thus confirm that another vehicle 18 is, for example, driving to the right of the vehicle 10.

With this information the vehicles can determine their position. In this example, position may be determined based on the principle that the vehicle 10 detects that another vehicle 18, is, for example, driving to the left of the vehicle 10 and concludes from this that the vehicle 10 cannot drive in the left lane 12. The knowledge of the lane 12 being driven in can likewise be transmitted to other vehicles 18 or other vehicles 18 transmit the knowledge of the lane 12 in which they are driving to the vehicle 10. From this the vehicles can conclude among themselves in which lane 12 they are located. Here an additional data source in the form of the knowledge of the road topology and accordingly the actual number of lanes 12 is provided.

With the aid of the side area sensor system of the environmental sensor system 14, it is further provided that the position of a guardrail 24 may be determined by means of detecting the reflective characteristics of objects and that depending on the position of the guardrail 24 the lateral position of the vehicle 10 on the road is determined. If the guardrail 24 is classified as an object, then based on the lateral offset of the position of the vehicle 10 to the guardrail 24, the lane 12 currently driven in can be determined. The classification as guardrail 24 is determined through the reflective characteristics of objects. To this end in this exemplary embodiment the side area sensor system is realized using radar.

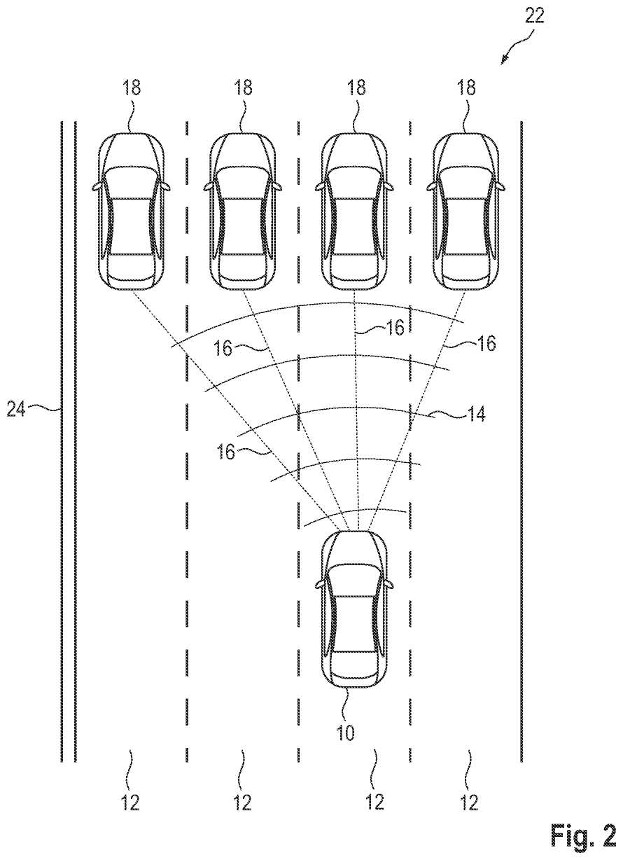

FIG. 2 shows an exemplary embodiment of the execution of a method for determining the lane 12 actually being driven in. In addition to the possibility of C2X communication, the vehicle 10 may be configured with a front sensor system as part of the environmental sensor system 14. By means of the front sensor system other vehicles ahead 18 can be detected. If other vehicles 18 are driving ahead of the vehicle 10, particularly with knowledge of the road topology, then the vehicle 10, using the other vehicles 18 detected, can determine its own lateral position on the road 22. Since the vehicles communicate via C2X communication, the vehicle 10 can also share with the vehicles 18 ahead their position. Likewise the other vehicles ahead 18, with knowledge of their own lateral position on the road, can determine the lateral position of the vehicle behind, i.e. of the vehicle 10, and share this position with the vehicle behind or the vehicle 10 via C2X communication 16.

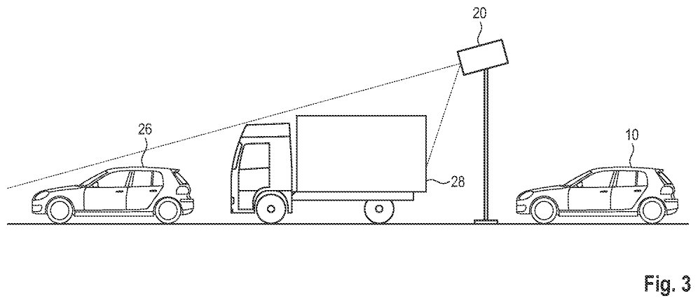

FIG. 3 shows the advantageous C2X communication 16 of the vehicle 10 with the infrastructure 20 in the form of a camera. A camera arranged at a height offers additional angles of view to identify additional vehicles 18 that might possibly be concealed by vehicles behind. As a prerequisite it is assumed that a vehicle driving ahead 26 is completely concealed by the vehicle behind 28. The vehicle ahead 26 sends a C2X message to the infrastructure 20. If the infrastructure 20 is for example, a camera, then by means of the angle of inclination and the resolution of the camera as well as through the determination of the height of the vehicle behind 28, the spaces ahead of the vehicle behind 28 are calculated. In this manner the position of the vehicle ahead 26 can be localized in both a lateral and a longitudinal position to a certain area, for example a lane 12, and thus more precisely determined.

### LIST OF REFERENCE NUMBERS

10 vehicle

12 lane

14 environmental sensor system

16 C2X communication

18 other vehicle

20 infrastructure

22 road

24 guardrail

26 vehicle ahead

28 vehicle behind

1. A method for assigning a lane for a vehicle, comprising:
detecting input variables of at least one data source to determine a current lane for the vehicle, wherein the at least one data source comprises (i) car-to-everything (C2X) signals from an environmental sensor system of the vehicle and (ii) information related to road topology;
determining the number of lanes of at least a road segment currently being driven by the vehicle using the data source;
detecting signals indicating a driving direction of one or more other vehicles in an environment of the vehicle;
processing the detected signals and the road topology to determine the position of the vehicle; and
using the determined position to execute a driver assistance function.

2. The method of claim 1, further comprising communicating C2X signals indicating the vehicle's position to the one or more other vehicles, and wherein the data source comprises C2X communication indicating the positions of the one or more other vehicles.

3. The method of claim 1, further comprising communicating information for the vehicle to infrastructure via C2X communication.

4. The method of claim 1, further comprising detecting environmental data for the vehicle via an environmental sensor system comprising radar and/or ultrasound.

5. The method of claim 1, further comprising detecting environmental data for the vehicle via an environmental sensor system comprising a side area sensor system, the side area sensor being configured to detect a lateral position of the vehicle used for determining the current lane for the vehicle.

6. The method of claim 1, further comprising detecting environmental data for the vehicle via an environmental sensor system comprising a front sensor system for determining positions of one or more other vehicles in the environment of the vehicle.

7. The method of claim 1, further comprising detecting environmental data for the vehicle via an environmental sensor system comprising a rear sensor system for determining rearward positions of the one or more other vehicles relative to the vehicle.

8. The method of claim 1, further comprising determining a lateral position of the vehicle using information relating to a position of a guardrail, determined by detecting a reflective characteristic.

9. A system for assigning a lane for a vehicle, comprising:
communications for communicating on a car-to-everything (C2X) network;
an environmental sensor system; and
a processing apparatus, operatively coupled to the environmental sensor system and communications, wherein the processing apparatus is configured to
detect input variables of at least one data source to determine a current lane for the vehicle, wherein the at least one data source comprises (i) C2X signals from the environmental sensor system of the vehicle and (ii) information related to road topology;
determine the number of lanes of at least a road segment currently being driven by the vehicle using the data source;
detect signals indicating a driving direction of one or more other vehicles in an environment of the vehicle;
process the detected signals and the road topology to determine the position of the vehicle; and
execute a driver assistance function using the determined position.

10. The system of claim 7, wherein the processing apparatus is configured to communicate C2X signals indicating the vehicle's position to the one or more other vehicles, and wherein the data source comprises C2X communication indicating the positions of the one or more other vehicles.

11. The system of claim 7, wherein the processing apparatus is configured to communicate information for the vehicle to infrastructure via C2X communication.

12. The system of claim 7, wherein the environmental sensor system comprises radar and/or ultrasound.

13. The system of claim 7, wherein the environmental sensor system comprises a side area sensor system, the side area sensor being configured to detect a lateral position of the vehicle used for determining the current lane for the vehicle.

14. The system of claim 7, wherein the environmental sensor system comprises a front sensor system for determining positions of one or more other vehicles in the environment of the vehicle.

15. The system of claim 7, wherein the environmental sensor system comprises a rear sensor system for determining rearward positions of the one or more other vehicles relative to the vehicle.

16. The system of claim 7, wherein the processing apparatus is configured to determine a lateral position of the vehicle using information relating to a position of a guardrail, determined by detecting a reflective characteristic.

17. A method for assigning a lane for a vehicle, comprising:
detecting input variables of at least one data source to determine a current lane for the vehicle, wherein the at least one data source comprises (i) car-to-everything (C2X) signals from an environmental sensor system of the vehicle and (ii) information related to road topology;
determining the number of lanes of at least a road segment currently being driven by the vehicle using the data source;
detecting signals indicating a driving direction of one or more other vehicles in an environment of the vehicle;
processing the detected signals and the road topology to determine the position of the vehicle; and
using the determined position to execute a driver assistance function.

18. The method of claim 17, further comprising
communicating C2X signals indicating the vehicle's position to the one or more other vehicles, and wherein the data source comprises C2X communication indicating the positions of the one or more other vehicles, and
communicating information for the vehicle to infrastructure via the C2X communication.

19. The method of claim 17, further comprising detecting environmental data for the vehicle via an environmental sensor system comprising one or more of
radar and/or ultrasound,
a side area sensor system, the side area sensor being configured to detect a lateral position of the vehicle used for determining the current lane for the vehicle,
a front sensor system for determining positions of one or more other vehicles in the environment of the vehicle, and/or
a rear sensor system for determining rearward positions of the one or more other vehicles relative to the vehicle.

20. The method of claim 17, further comprising determining a lateral position of the vehicle using information relating to a position of a guardrail, determined by detecting a reflective characteristic.
